(19) United States
(12) Patent Application Publication
(10) Pub. No.: US 2021/0117741 A1
(43) Pub. Date: Apr. 22, 2021

(54) PRINT CONTROL SYSTEM, PRINT CONTROL METHOD, AND COMPUTER READABLE RECORDING MEDIUM STORING PRINT CONTROL INSTRUCTIONS

(71) Applicant: Konica Minolta, Inc., Tokyo (JP)

(72) Inventor: Munetoshi Eguchi, Tokyo (JP)

(73) Assignee: Konica Minolta, Inc., Tokyo (JP)

(21) Appl. No.: 17/024,319

(22) Filed: Sep. 17, 2020

(30) Foreign Application Priority Data
Oct. 21, 2019 (JP) 2019-191626

(51) Int. Cl. G06K 15/02; G06F 3/12

(52) U.S. Cl. CPC G06K 15/1836; G06F 3/1298; G06F 3/1248; G06F 3/1211

(57) ABSTRACT

A print control system that outputs a video signal to a printer, includes: a plurality of print controllers including a first print controller and a second print controller. The first print controller is connected to a printer and includes an administrator that acquires a print job comprising image information, divides the image information of the acquired print job, and distributes the divided image information to the first print controller and the second print controller; and a first RIP processor that generates image data by rasterizing the image information distributed to the first print controller. The second print controller includes a second RIP processor that generates the image data by rasterizing the image information distributed to the second print controller.

### CROSS-REFERENCE TO RELATED APPLICATION

The entire disclosure of Japanese patent application No. 2019-191626, filed on Oct. 21, 2019, is incorporated herein by reference.

### BACKGROUND

### 1. Technological Field

The present invention relates to a print control system, a print control method, and a computer readable recording medium storing print control instructions. In particular, the present invention relates to a print control system including a plurality of print controllers each of which performs RIP (Raster Image Process) processing, a print control method in the print control system, and a computer readable recording medium storing print control instructions that operate in any one of the print controllers.

### 2. Description of the Related Arts

In order to reduce a cycle down time of a printer and to prevent a blank region, it is necessary to attain speeding up of RIP processing in a print controller (referred to as a DEF (Digital Front End)). Accordingly, various methods have been proposed. As a method of attaining speeding up of RIP processing, cited are a method of using a high-performance CPU (Central Processing Unit), a method of executing RIP processing by hardware, a method of distributing RIP processing, and the like.

In particular, as the method of distributing RIP processing, a print control system (referred to as a scalable DFE system) in which a plurality of DFEs are connected, has been proposed, and it has been put in practical use in some area. This scalable DFE system is operated by using one DFE or a plurality of DFEs. That is, depending on a printing speed of a printer or a situation utilized by a customer, the number of DFEs is made to be able to be changed arbitrarily.

Although being not a system to connect a plurality of print controllers, as a technique to provide a plurality of processing functions (blade) within one print controller, for example, Patent Literature 1 (JP 2013-161135A) discloses a print controller that processes data by a plurality of blades. The print controller includes a RIP unit that creates an image from the data, a storage unit that saves the image, and a control unit that controls the RIP unit and the storage unit. In this print controller, at least the RIP unit and the storage unit are provided in the respective blades. Moreover, on the basis of a detection result of a situation of a plurality of the storages, the control unit selects the blade in which the RIP unit used for forming the image is provided and the blade in which the storage unit used for saving the image is provided, respectively.

In the conventional scalable DFE system that executes RIP processing by using a plurality of DFEs, at the time of transferring RIP-treated image data (image data having been treated by RIP) to a printer, it is necessary to collect the RIP-treated image data to a DFE connected to the printer. Accordingly, it is necessary to provide resources, such as a memory or storage with a sufficient capacity to a DFE to be connected to the printer.

On the other hand, a scalable DFE system may be operated as a system even with one DFE. Accordingly, there may be a case where an inexpensive entry model has been employed as the first one DFE and, at later days, a plurality of DFEs are additionally employed. In this case, in the DFE being the entry model connected to a printer, there is a possibility that resources, such as a memory and a storage, may become insufficient.

### SUMMARY

One or more embodiments of the present invention provide a print control system, print control method, and print control instructions, with which it is possible to additionally provide a DFE without providing resources, such as a memory or storage with large capacity to a DFE to be connected to a printer.

According to one or more embodiments of the present invention, a print control system that outputs a video signal to a printer and includes: a plurality of print controllers. One print controller to be connected to a printer among the plurality of print controllers includes: an administrator that acquires a print job including image information, divides the image information of the acquired print job, and distributes the divided image information to the one print controller and other print controller other than the one print controller, and a first RIP processor that generates image data by rasterizing the image information distributed to the one print controller. The other print controller includes a second RIP processor that generates image data by rasterizing the image information distributed to the other print controller. The one print controller further includes a switcher that makes one of the first RIP processor and the second RIP processor generate image data at a timing according to a distribution result and switches an output route so as to output the image data generated by the one of the first RIP processor and the second RIP processor to the printer.

According to one or more embodiments of the present invention, a print control method in a print control system that includes a plurality of print controllers and outputs a video signal to a printer, includes: executing, by one print controller to be connected to the printer among the plurality of print controllers, distribution processing that acquires a print job including image information, divides the image information of the acquired print job, and distributes the divided image information to the one print controller and other print controller other than the one print controller, and first RIP processing that generates image data by rasterizing the image information distributed to the one print controller, executing, by the other print controller, second RIP processing that generates image data by rasterizing the image information distributed to the other print controller; and executing, further by the one print controller, switch processing that makes one of the first RIP processing and the second RIP processing to be executed at a timing according to a distribution result and switches an output route so as to output the image data generated by the one of the first RIP processing and the second RIP processing to the printer.

According to one or more embodiments of the present invention, a non-transitory recording medium storing computer readable print control instructions that operate in a print control system that includes a plurality of print controllers and outputs a video signal to a printer. The print control instructions include: making one print controller to be connected to the printer among the plurality of print controllers, execute distribution processing that acquires a print job including image information, divides the image information of the acquired print job, and distributes the divided image information to the one print controller and other print controller other than the one print controller, and switch processing that makes one of the one print controller and the other print controller execute RIP processing so as to generate image data by rasterizing the distributed image information at a timing according to a distribution result and switches an output route so as to output the image data generated in the RIP processing executed by the one of the one print controller and the other print controller to the printer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic drawing showing an outlined configuration of a printing system according to a first example of one or more embodiments of the present invention.

FIG. 2 is a block diagram showing a configuration of a scalable DFE system according to the first example of one or more embodiments of the present invention.

FIG. 3 is a table showing a RIP processing capability of each DFE according to the first example of one or more embodiments of the present invention.

FIG. 4 is a table showing RIP prediction of each page and a distribution result of a RIP according to the first example of one or more embodiments of the present invention.

FIG. 5 is a schematic drawing showing a relationship between a RIP time and a printing time according to the first example of one or more embodiments of the present invention.

FIG. 6 is a timing chart diagram of an HW signal of the scalable DFE system according to the first example of one or more embodiments of the present invention.

FIG. 7 is a flowchart diagram showing an operation of the scalable DFE system according to the first example of one or more embodiments of the present invention.

FIG. 8 is one example of a screen displayed in a printing system according to the first example of one or more embodiments of the present invention.

FIG. 9 is a schematic drawing showing a relationship between a RIP time and a printing time. according to a second example of one or more embodiments of the present invention.

FIG. 10 is a timing chart diagram of an HW signal of a scalable DFE system according to the second example of one or more embodiments of the present invention.

FIG. 11 is a flowchart diagram showing an operation of the scalable DFE system according to the second example of one or more embodiments of the present invention.

FIG. 12 is a schematic drawing showing an outlined configuration of a printing system according to a third example of one or more embodiments of the present invention.

FIG. 13 is a table showing RIP prediction and a RIP distribution result of each page according to the third example of one or more embodiments of the present invention.

FIG. 14 is a schematic drawing showing a relationship between a RIP time and a printing time according to the third example of one or more embodiments of the present invention.

FIGS. 15A and 15B are flowchart diagrams showing an operation of a scalable DFE system according to the third example of one or more embodiments of the present invention.

FIG. 16 is a schematic drawing showing an outlined configuration of a conventional printing system.

### DETAILED DESCRIPTION

Hereinafter, with reference to attached drawings, embodiments of the present invention will be described. However, the scope of the invention is not limited to the disclosed embodiments.

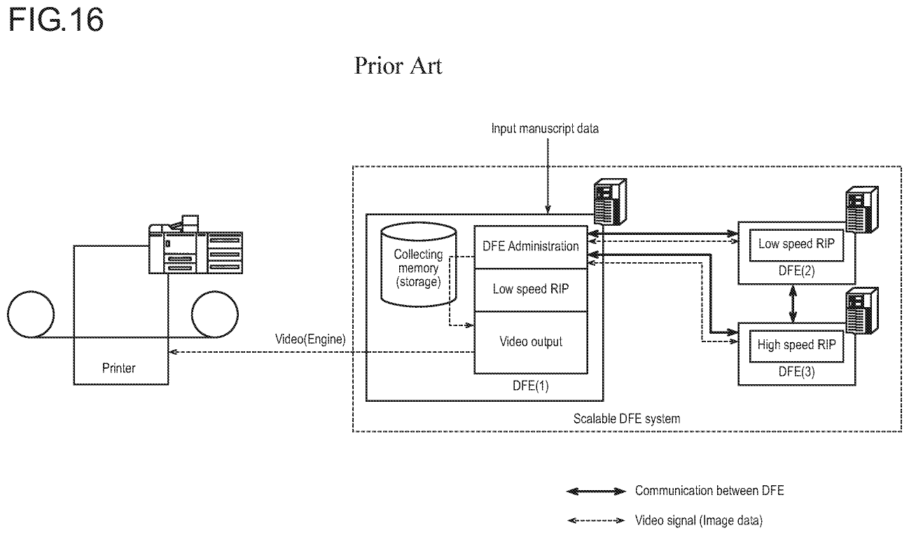

As having showed in DESCRIPTION OF RELATED ARTS, as a method of attaining speeding up of RIP processing in a print controller (DFE), there is a method of distributing RIP processing. As the method, a scalable DFE system as shown in FIG. 16 has been proposed. This scalable DFE system is operated by using one DFE through a plurality of DFEs (in FIG. 16) three DFEs (DFE (1) to DFE (3)). Depending on a printing speed of a printer or a situation utilized by a customer, it is possible to change the number of DFEs arbitrarily. That is, RIP processing is executed by using a plurality of DFEs, whereby speeding up of the RIP processing is attained.

However, in the conventional scalable DFE system as shown in FIG. 16, there is a need to collect RIP-treated image data into a DFE (in FIG. 16, DFE (1)) connected to a printer. Accordingly, it is necessary to provide resources (in FIG. 16, a collecting memory), such as a memory or storage with a sufficient capacity to a DFE connected to a printer. For that reason, in the case where an inexpensive entry model has been employed as the first one DFE and, at later days, a plurality of DFEs are additionally employed, there is a possibility that resources, such as a memory or storage, become insufficient in the DFE of the entry model connected to a printer.

Then, in one or more embodiments of the present invention, the RIP-treated image data of a plurality of DFEs is not collected into one DFE (is not memorized in a memory or storage of one DFE), but switching of video interfaces (VIF) is made to be performed in a DFE connected to a printer.

In concrete terms, in a print control system that includes a plurality of print controllers and outputs a video signal to a printer, one print controller to be connected to a printer among the plurality of print controllers includes an administrator that acquires a print job including image information, divides the image information of the acquired print job, and distributes the divided image information to the one print controller and other print controller other than the one print controller and a first RIP processor that generates image data by rasterizing the image information distributed to the one print controller, the other print controller includes a second RIP processor that generates image data by rasterizing the image information distributed to the other print controller, and the one print controller further includes a switcher that makes one of the first RIP processor and the second RIP processor generate the image data at a timing according to a distribution result and switches an output route so as to output the image data generated by the one of the first RIP processor and the second RIP processor to the printer.

In this way, by providing a switcher to switch an output route of a video signal to a DFE to be connected to a printer and by switching video signals of a plurality of DFEs and outputting a video signal, it possible to configure a scalable DFE system by additionally providing a DFE arbitrarily without providing a memory or storage with a large capacity to a DFE connected to a printer.

### EXAMPLE 1

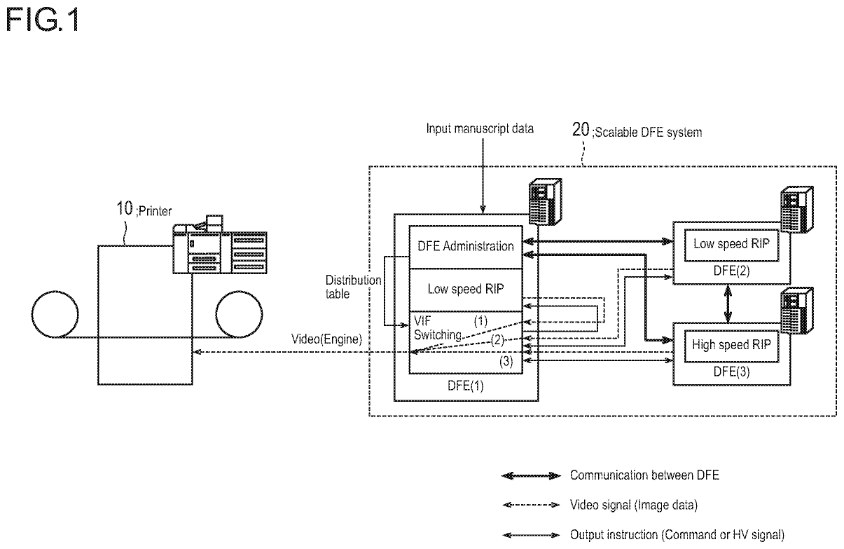

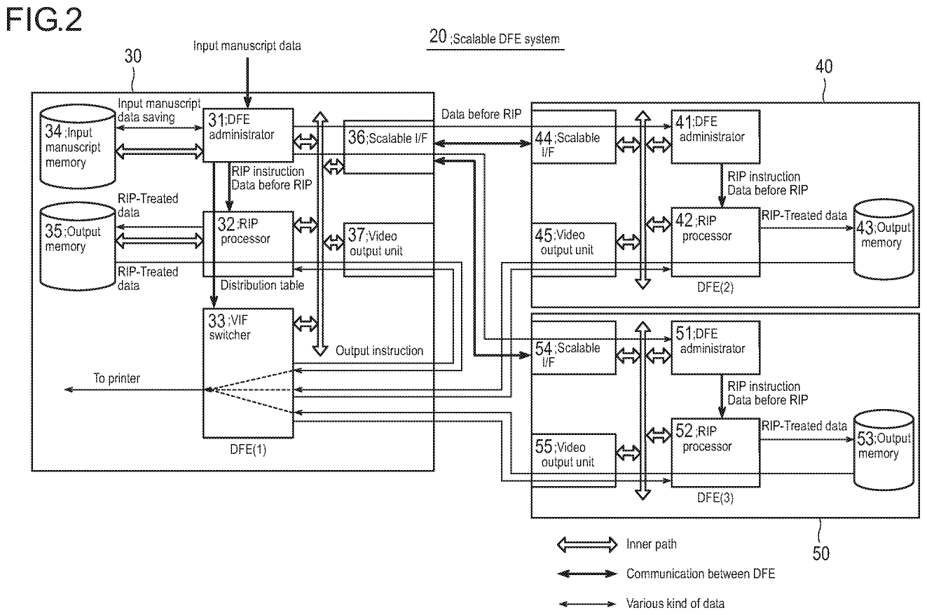

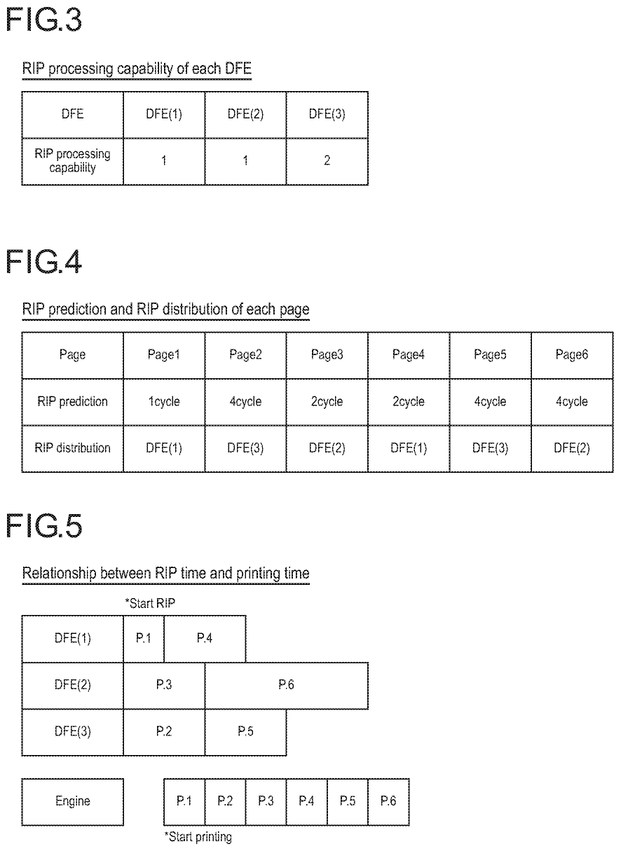

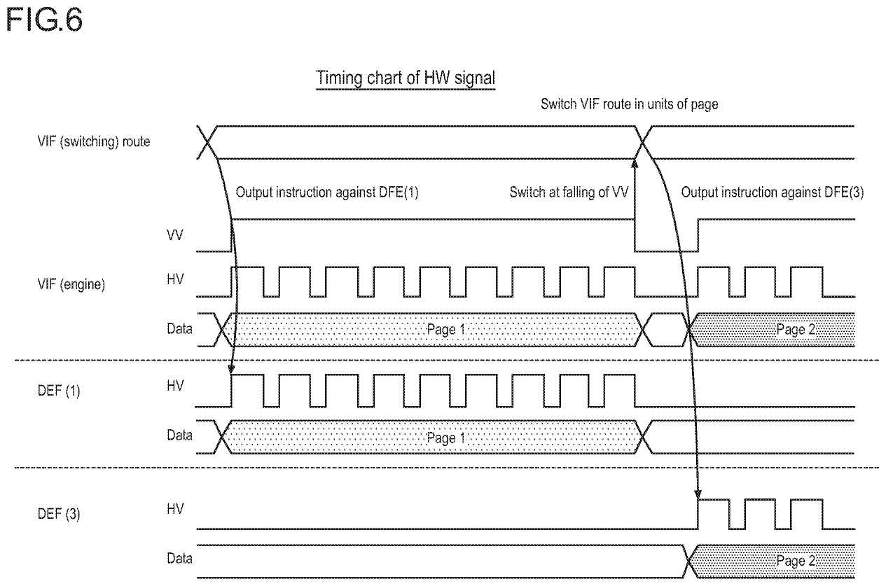

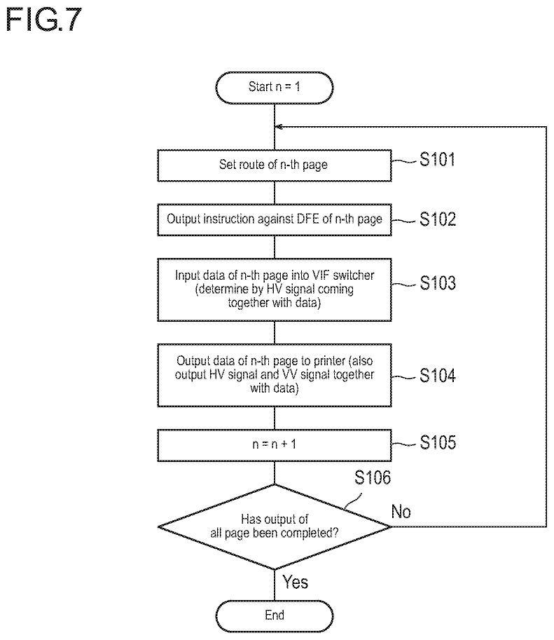

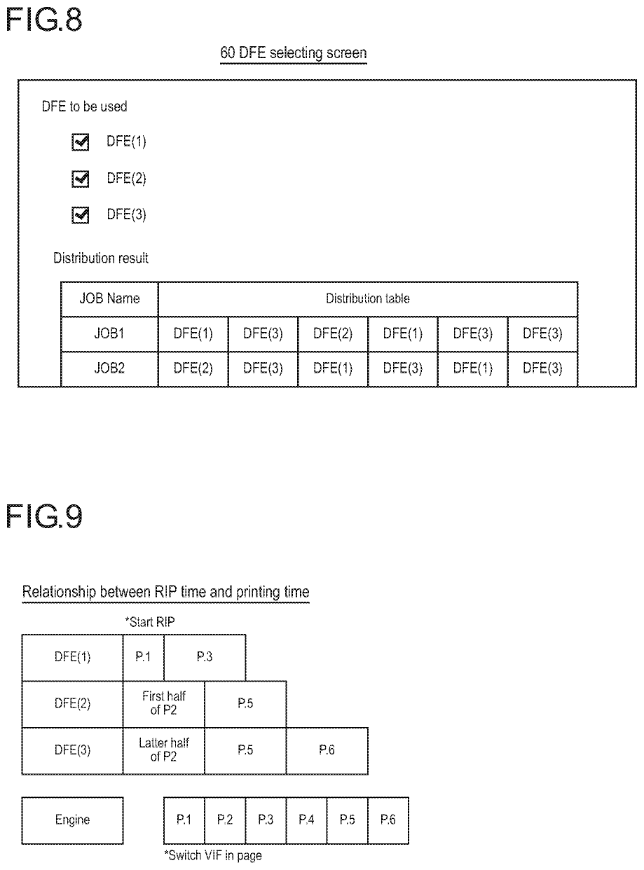

In order to describe the above-described embodiments of the present invention in detail, a print control system, print control method, and print control instructions according to a first example of one or more embodiments of the present invention will be described with reference to FIG. 1 through FIG. 8. FIG. 1 is a schematic drawing showing an outlined configuration of a printing system of the present example, and FIG. 2 is a block diagram showing a configuration of a scalable DFE system. Moreover, FIG. 3 is a table showing a RIP processing capability of each DFE, FIG. 4 is a table showing RIP prediction and RIP distribution result of each page, and FIG. 5 is a schematic drawing showing a relationship between a RIP time and a printing time. Moreover, FIG. 6 is a timing chart diagram of an HW signal, FIG. 7 is a flowchart diagram showing an operation of a scalable DFE system of the present example, and FIG. 8 is one example of a screen displayed in a printing system of the present example.

As shown in FIG. 1, the printing system of the present example includes a printer (engine) 10 that executes print processing and a print control system (scalable DFE system) 20 that outputs a video signal (image data) to the printer 10. The scalable DFE system 20 includes a plurality of print controllers (DFE), and a DFE to be connected to the printer 10 is configured so as to be able to perform the switching (switching of VIF) of an output route of a video signal.

In this connection, in the scalable DFE system 20 of the present example, the plurality of DFEs do not need to have the same specification, and their specifications can be set arbitrarily according to a printing speed and Roll-to-Roll system of the printer 10, a usage situation of a customer, and the like, respectively.

Moreover, usually, a print controller includes a printer I/F for connecting with the printer 10. However, in the present example, a predetermined print controller among the plurality of print controllers is connected to the printer 10, and the other print controllers are connected to the predetermined print controller (do not need to be connect to the printer 10). Accordingly, the other print controllers do not need to include the printer I/F. Hereinafter, each device will be described.

The printer 10 is an image forming apparatus, such as MFP (Multi-Functional Peripherals) that form an image by superimposing colors on a sheet on the basis of a video signal (image data) received from the print controller. For example, the printer 10 is an image forming apparatus of a tandem system in which photoconductors corresponding to four colors of yellow (Y), magenta (M), cyan (C), and black (K) are disposed serially in the traveling direction of a transfer receiving body (intermediate transfer belt).

The scalable DFE system 20 includes, as shown in FIG. 2, a first print controller (DFE 30, hereinafter, referred to as DFE (1)) that is connected to the printer 10, and a second print controller (DFE 40, hereinafter, referred to as DFE (2)) and a third print controller (DFE 50, hereinafter, referred to as DFE (3)) that are connected to the first print controller. Each of the DFEs includes a processor constituted with a CPU and memories, such as a ROM (read only memory) and a RAM (random access memory).

The processor of the DFE (1) to be connected to the printer 10 includes a DFE administrator 31, a RIP processor 32, a VIF switcher 33, an input manuscript memory 34, an output memory 35, a scalable I/F 36, a video output unit 37, and the like.

The DFE administrator 31 (recited as an administrator in claims) acquires a print job (hereinafter, referred to as input manuscript data) including image information described with a PDL (Page Description Language) etc. represented by PostScript and a PCL (Printer Control Language) from external devices and stores the acquired input manuscript data in an input manuscript memory 34. Moreover, the DFE administrator 31 takes input manuscript data out from the input manuscript memory 34, divides the image information of the input manuscript data on the basis of the RIP processing capability of each of the DFEs, the printing speed of the printer 10, and the like, and distributes the divided image information to the DFE (1) and the other DFEs (DFE (2) and DFE (3)). Successively, the DFE administrator 31 outputs the data (data before being subjected to RIP) of some of the divided image information (page) to the RIP processor 32 and performs a RIP instruction. Alternately, the DFE administrator 31 transmits the data before being subjected to RIP of the image information (page) other than the above some to the DFE administrators of the other DFEs through the scalable I/F 36. Moreover, the DFE administrator 31 creates a table (distribution table) showing a distribution result of the divided image information and outputs the distribution table to the VIF switcher 33.

The RIP processor 32 (recited as a first RIP processor in claims) rasterizes the data (data before being subjected to RIP) of image information (page) of some of input manuscript data in accordance with an instruction from the VIF switcher 33, thereby generating image data. Successively, the RIP processor 32 performs image processing (processing such as color adjustment, density adjustment, size adjustment, etc.) and screening if needed for the image data, thereby converting the image data into image data (RIP-treated data (data having been treated by RIP)) capable of being printed in the printer 10. Subsequently, the RIP processor 32 saves the RIP-treated data in the output memory 35.

The VIF switcher 33 (recited as a switcher in claims) makes one of the RIP processor 32 of the DFE (1) and the RIP processors of the other DFEs generate image data at a timing according to the distribution table received from the DFE administrator 31, and then, the VIF switcher 33 switches the output routes so as to output the image data generated by the one of the RIP processor 32 and the RIP processors to the printer 10. In concrete terms, the VIF switcher 33 performs an output instruction for a video output unit 37 of the DFE (1) or a video output unit of the other DFE, and then, the VIF switcher 33 switches the RIP-treated data saved in the output memory 35 of the DFE (1) and the RIP-treated data saved in the output memory of the other DFE and outputs the RIP-treated data to the printer 10.

The input manuscript memory 34 saves the input manuscript data received from the DFE administrator 31.

The output memory 35 saves the RIP-treated data received from the RIP processor 32.

The scalable I/F 36 is an I/F, such as a NIC (Network Interface Card) and modem that make it possible to communicate with other DFE, and the scalable I/F 36 transmits data before being subjected to RIP to the other DFE or receives RIP-treated data from other DFE.

In accordance with an output instruction from the VIF switcher 33, the video output unit 37 takes RIP-treated data out from the output memory 35 and outputs the RIP-treated data to the VIF switcher 33.

In this connection, the above-described DFE administrator 31, RIP processor 32, VIF switcher 33, and video output unit 37 may be configured as hardware. Alternatively, print control instructions are configured to make the processor function as the DFE administrator 31, the RIP processor 32, the VIF switcher 33, and the video output unit 37 (especially, as the DFE administrator 31, the RIP processor 32, and the VIF switcher 33), and the CPU of the processor is configured to execute the print control instructions.

Moreover, the processor of the DFE (2) to be connected to the DFE (1) includes a DFE administrator 41, a RIP processor 42, an output memory 43, a scalable I/F 44, a video output unit 45, and the like. Moreover, the processor of the DFE (3) to be connected to the DFE (1) includes a DFE administrator 51, a RIP processor 52, an output memory 53, a scalable I/F 54, a video output unit 55, and the like.

The DFE administrator 41 (51) receives the data (data before being subjected to RIP) of image information (page) other than the above some of the input manuscript data from the DFE administrator 31 of the DFE (1) through the scalable I/F 44 (54). Moreover, the DFE administrator 41 (51) outputs the received data before being subjected to RIP to the RIP processor 42 (52) and performs a RIP instruction for the RIP processor 42 (52).

The RIP processor 42 (52) (recited as a second RIP processor in claims) rasterizes the data before being subjected to RIP in accordance with an instruction from the VIF switcher 33 of the DFE (1), thereby generating image data. Successively, the RIP processor 42 (52) performs image processing (processing such as color adjustment, density adjustment, size adjustment, etc.) and screening if needed for the image data, thereby converting the image data into image data (RIP-treated data) capable of being printed in the printer 10. Subsequently, the RIP processor 42 (52) saves the RIP-treated data in the output memory 43 (53).

The output memory 43 (53) saves the RIP-treated data received from the RIP processor 42 (52).

The scalable I/F 44 (54) is an I/F, such as a NIC and modem that make it possible to communicate with the DFE (1), and the scalable I/F 44 (54) receives data before being subjected to RIP from the DFE (1) or transmits RIP-treated data to the DFE (1).

In accordance with an output instruction from the VIF switcher 33 of the DFE (1), the video output unit 45 (55) takes RIP-treated data out from the output memory 43 (53) and outputs the RIP-treated data to the VIF switcher 33 of the DFE (1) through the scalable I/F 44 (54).

In this connection, FIG. 1 and FIG. 2 show one example of the scalable DFE system 20 of the present example, and its configuration can be changed appropriately. For example, in FIG. 1 and FIG. 2, the scalable DFE system 20 is configured with three DFEs. However, as long as including a DFE to be connected to the printer 10 and at least one other DFE to be connected to the DFE, the scalable DFE system 20 may be permissible.

Next, the operation of the scalable DFE system 20 with the above-described configuration is described.

The input manuscript data is input into the DFE administrator 31 of the DFE (1). On the basis of prediction of the RIP processing time of each page of the input manuscript data, the DFE administrator 31 distributes the respective pages of the input manuscript data to DFEs that can perform RIP processing within a printing speed, respectively. For example, it is assumed that the RIP processing capability of the RIP processor of each of the DFEs is a corresponding one of values shown in FIG. 3. In this connection, in the case where a capability to process one cycle of RIP prediction within one cycle is made a standard capability, each of the values of FIG. 3 represents that its capability is how many times the standard capability. Then, in the case where the RIP prediction of each page of the input manuscript data becomes as shown in FIG. 4, the distribution of the RIP processing is performed in the following way. That is, in a page with a relatively large RIP prediction, the RIP processing is performed by the DFE (3) with a relatively high RIP processing capability. On the other hand, in a page with a relatively small RIP prediction, the RIP processing is performed by the DFE (1) or the DFE (2) with a relatively low RIP processing capability.

Thereafter, in accordance with the distribution result of the RIP, the DFE administrator 31 transmits the data before being subjected to RIP of the page distributed to the DFE (1) to the RIP processor 32 and instructs the RIP processing. In addition, the DFE administrator 31 transmits the data before being subjected to RIP of the page distributed to each of the DFE (2) and the DFE (3) to the DFE administrator of each of the DFE (2) and the DFE (3) through the scalable I/F 36. The DFE administrator of each of the DFE (2) and the DFE (3) transmits the data before being subjected to RIP to the RIP processor and instructs the RIP processing. Then, the RIP processor of each of the DFEs performs the RIP processing and saves the RIP-treated data in the output memory.

Moreover, the DFE administrator 31 notifies the VIF switcher 33 of a table (distribution table) that describes a distribution result. In accordance with the distribution table, the VIF switcher 33 determines the route of the VIF for each page and instructs the video output unit 37 of the DFE (1) to output the RIP-treated data. In addition, the VIF switcher 33 instructs, through the scalable I/F 36, the video output unit of each of the DFE (2) and the FE (3) to output the RIP-treated data. Then, the video output unit reads out the RIP-treated data from the output memory and transmits the RIP-treated data to the VIF switcher 33.

For example, as shown in the schematic drawing in FIG. 5, upon completion of the RIP processing for the page 1 in the RIP processor 32, the VIF switcher 33 outputs the RIP-treated data to the printer 10 and makes the printer 10 start printing. Thereafter, the VIF switcher 33 notifies each DFE of an output instruction (a command or a HV signal), and then, each DFE starts the output of the RIP-treated data by making any one of the command and the HV signal as a trigger. Successively, if the RIP-treated data is input into the VIF switcher 33, the VIF switcher 33 transmits the RIP-treated data to the printer 10.

FIG. 6 is a timing chart of an HW signal. In FIG. 6, HV denotes a horizontal synchronizing signal, VV denotes a vertical synchronizing signal, Data denotes a signal of RIP-treated data. The VIF switcher 33 instructs the video output unit 37 of the DFE (1) to output. Then, the video output unit 37 transmits a HV signal and a VV signal if needed together with a signal of the RIP-treated data of page 1, and the printer 10 (engine) starts printing of the first page. The VIF switcher 33 performs the switching of the VIF at the timing of the falling of the VV signal (or at a timing when the HV signal has become Low by a predetermined number of times) and instructs the video output unit 55 of the DFE (3) to output. Then, the video output unit 55 of the DFE (3) transmits an HV signal and a VV signal if needed together with a signal of the RIP-treated data of page 2, and the printer 10 (engine) starts printing of the second page.

Hereinafter, the operation of the scalable DFE system 20 of the present example will be described with reference to FIG. 7. The processor of the DFE (1) develops the print control instructions memorized in a ROM and the like into a RAM and executes the print control instructions, thereby executing the processing of each step shown in a flowchart in FIG. 7.

First, the DFE administrator 31 performs the distribution of the RIP processing on the basis of the RIP processing capability (refer to FIG. 3) of each DFE and the RIP prediction (refer to FIG. 4) of each page and sets the route (DFE that executes the RIP processing) of the n-th page (S101). Next, the DFE administrator 31 performs an output instruction against the DFE administrator of the DFE to which the n-th page is distributed (S102). Then, the DFE administrator instructs the RIP processor to perform the RIP processing for the n-th page and instructs the video output unit to output the RIP-treated data of the n-th page.

Next, when the RIP-treated data of the n-th page has been input (S103), the VIF switcher 33 outputs the RIP-treated data of the n-th page to the printer 10 together with an HV signal and a VV signal if needed (S104). In this connection, whether the RIP-treated data of the n-th page has been inputted or not, can be determined on the basis of the HV signal that is transmitted together with the RIP-treated data.

Next, the VIF switcher 33 adds one to the n (S105) and determines whether the output of all the pages has been completed (S106). In the case where the output of all the pages has not been completed (No in S106), the processing returns to S101. Then, the route for the next page is set, and the similar processing is repeated. As a result, in the case where the output of all the pages has been completed (Yes in S106), a series of processing will be ended.

In the above, although the RIP processing has been distributed by using three DFEs of the DFEs (1) to (3), it is also possible that a user selects a DFE to be used for the distribution of the RIP processing. In such a case, a display unit (UI: User Interface) of any one of the DFEs (e.g., DFE (1)) or the printer 10 is made to display a DFE selecting screen 60 as shown in FIG. 8, and then, on the DFE selecting screen 60, each DFE included in the scalable DFE system 20 is displayed so as to be selectable. At that time, a distribution table (here, the distribution table of each job) may be displayed in the case of executing distribution processing by a DFE selected on the DFE selecting screen 60. Moreover, in the case where the RIP processing is not in time for printing, the fact that the RIP processing is not in time for printing may be notified. By performing such a notification, a user is allowed to select a DFE again.

As described in the above, in the scalable DFE system 20 including a plurality of DFEs, a VIF switcher is provided on any one of the DFEs. Then, in accordance with a distribution table prepared on the basis of the RIP processing capability of each DFE and the RIP prediction of each page, the VIF switcher instructs each DFE to perform outputting. Accordingly, without providing a memory or storage with a large capacity to a DFE to be connected to the printer 10, it is possible to execute RIP processing by distributing the RIP processing to the plurality of DFEs.

In particular, according to the print control system, print control method, and print control instructions according to one or more embodiments, it is possible to provide a DFE additionally without providing resources, such as a memory and storage with a large capacity to a DFE to be connected to a printer.

The reason of the above matter is that in a print control system that includes a plurality of print controllers and outputs a video signal to a printer, one print controller connected to a printer among the plurality of print controllers includes an administrator that acquires a print job including image information, divides the image information of the acquired print job, and distributes the divided image information to the one print controller and other print controller other than the one print controller and a first RIP processor that generates image data by rasterizing the image information distributed to the one print controller; the other print controller includes a second RIP processor that generates image data by rasterizing the image information distributed to the other print controller; and the one print controller further includes a switcher that makes one of the first RIP processor and the second RIP processor generate image data at a timing according to a distribution result and switches an output route so as to output the image data generated by the one of the first RIP processor and the second RIP processor to the printer.

### EXAMPLE 2

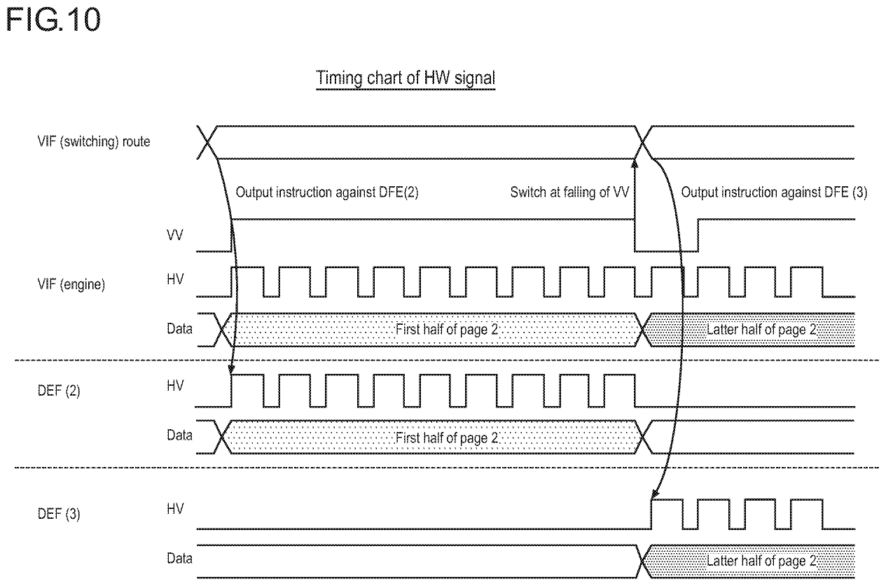

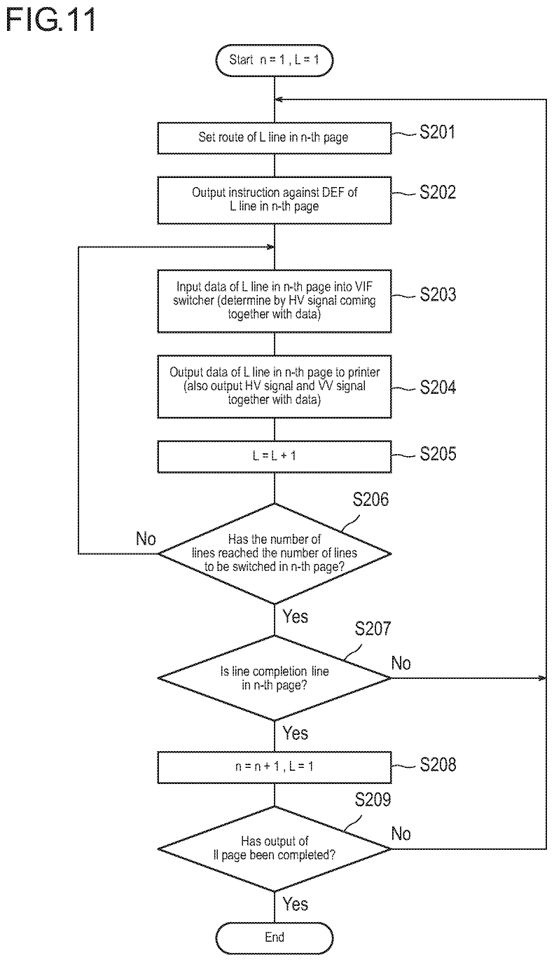

Next, a print control system, a print control method, and print control instructions according to a second example of one or more embodiments of the present invention will be described with reference to FIG. 9 through FIG. 11. FIG. 9 is a schematic drawing showing a relationship between a RIP time and a printing time. Moreover, FIG. 10 is a timing chart diagram of an HW signal, and FIG. 11 is a flowchart diagram showing an operation of a scalable DFE system of the present example.

In the above-described first example, a case where a DFE is switched in units of pages, has been described. However, depending on image information in a page, there may be a case where, by one DFE, the RIP processing may not be in time for printing. Then, in the case of having determined that the RIP processing being performed by using one DFE is not in time for printing, the RIP processing is performed by a plurality of DFEs. That is, in the middle of the page (for example, in units of images (objects) in a page), it is made to make possible to switch DFEs. In this case, the system configuration is similar to that in the first example. However, the DFE administrator 31 of the DFE (1) is configured to divide the image information of input manuscript data in the sub-scanning direction within a page.

In this connection, in the present example, it is assumed that DFEs are switched over in units of images (objects) in a page. However, it is also possible to switch DFEs over in the middle of an image (object). For example, in the case of bit map data (image object), data up to a predetermined line may be output to one DFE, and data after the predetermined line may be output to other DFE. Moreover, in the case of vector data (figure object), two sets of vector data divided at a predetermined line are prepared, and then, one set of vector data is output to one DFE, and another set of vector data is output to other DFE.

Hereinafter, an operation of the scalable DFE system of the present example will be described. In this connection, the distribution of RIP is performed in units of images in a page.

For example, in the case where page 2 is 8 cycles, and in the case where RIP processing performed by using only one DFE is not in time for printing even if the used DFE is the DFE (3) having high RIP capability, as shown in FIG. 9, the RIP processing is performed by dividing the page 2 into the first half of the page 2 and the latter half of the page 2 and distributing them to the DFE (2) and the DFE (3).

FIG. 10 is a timing chart of an HW signal in that case. When outputting the page 2, the VIF switcher 33 selects the DFE (2) first and instructs a video output unit to output. The video output unit transmits an HV signal and a VV signal if needed together with the signal of the RIP-treated data of the first half of the page 2. Here, the VIF switcher 33 is counting the number of lines (the number of times that the HV has become High) that the video output unit has output. Then, when the counted number of lines has reached a prescribed count number, the VIF switcher 33 switches from the next line from the DFE (2) to the DFE (3). Successively, the video output unit of the DFE (3) transmits an HV signal and a VV signal if needed together with the signal of the RIP-treated data of the latter half of the page 2.

In this connection, at the time of switching the VIF routes, the VV signal that is a page signal may not be omitted. By not omitting VV, the printer 10 can receive the image data corresponding in amount to one page without being aware that the route of the VIF has been switched in the page. Accordingly, it becomes unnecessary to perform the changing of the system of the existing printer 10.

Hereinafter, an operation of the scalable DFE system 20 of the present example will be described with reference to FIG. 11. The processor of the DFE (1) develops the print control instructions memorized in a ROM and the like into a RAM and executes the print control instructions, thereby executing the processing of each step shown in a flowchart diagram in FIG. 11.

First, the DFE administrator 31 performs the distribution of the RIP processing on the basis of the RIP processing capability (refer to FIG. 3) of each DFE and the RIP prediction (refer to FIG. 4) of each page and sets the route (DFE that executes the RIP processing) of L lines of the n-th page (S201). Next, the DFE administrator 31 performs an output instruction against the DFE administrator of the DFE to which the L lines of the n-th page are distributed (S202). Then, the DFE administrator instructs the RIP processor to perform the RIP processing for the n-th page (or, the L lines of the n-th page) and instructs the video output unit to output the RIP-treated data of the L lines of the n-th page.

Next, when the RIP-treated data of the L lines of the n-th page has been input (S203), the VIF switcher 33 outputs an HV signal and a VV signal if needed together with the RIP-treated data of the L lines of the n-th page to the printer 10 (S204). In this connection, whether the RIP-treated data of the L lines of the n-th page has been inputted or not, can be determined on the basis of the HV signal that is transmitted together with the RIP-treated data.

Next, the VIF switcher 33 adds one to the L (S205) and determines whether the number of lines has reached the number of lines (division line) to be switched in the n-th page (S206). In the case where the number of lines has not reached the number of lines to be switched in the n-th page (No in S206), the processing returns to S203, and the similar processing is repeated. As a result, in the case where the number of lines has reached the number of lines to be switched in the n-th page (Yes in S206), whether the line is the completion line in the n-th page, is determined (S207). In the case where the line is not the completion line in the n-th page (No in S207), the processing returns to S201, and the similar processing is repeated.

On the other hand, in the case where the line is the completion line in the n-th page (Yes in S207), the VIF switcher 33 adds one into the n and, in addition, substitutes one for the L (S208). Then, the VIF switcher 33 determines whether the output of all the pages has been completed (S209). In the case where the output of all the pages has not been completed (No in S209), the processing returns to S201, and the similar processing is repeated. As a result, in the case where the output of all the pages has been completed (Yes in S209), a series of processing will be ended.

As described in the above, by switching the DFE that executes the RIP processing, in the middle of a page (in units of images (objects)), even in the case where RIP processing by using one DFE is not in time for printing, it is possible to make the RIP processing become in time for printing. Moreover, by not omitting a VV signal at the time of switching the route of the VIF, it is possible to execute RIP processing by distributing the RIP processing without changing the system of the existing printer.

### EXAMPLE 3

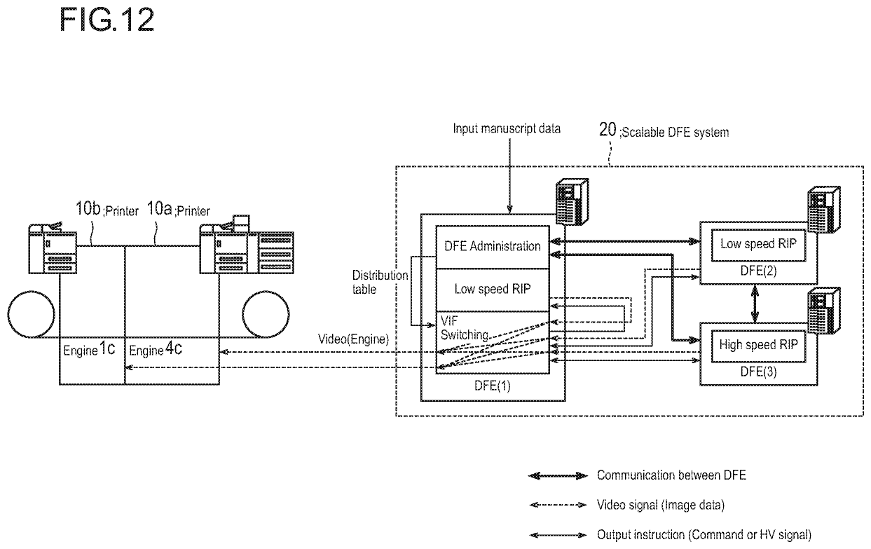

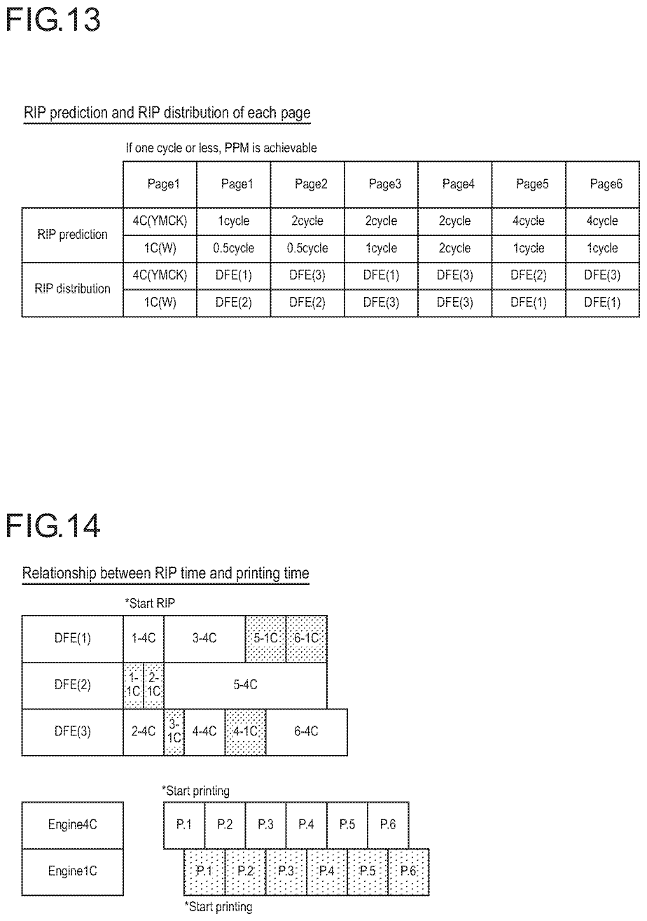

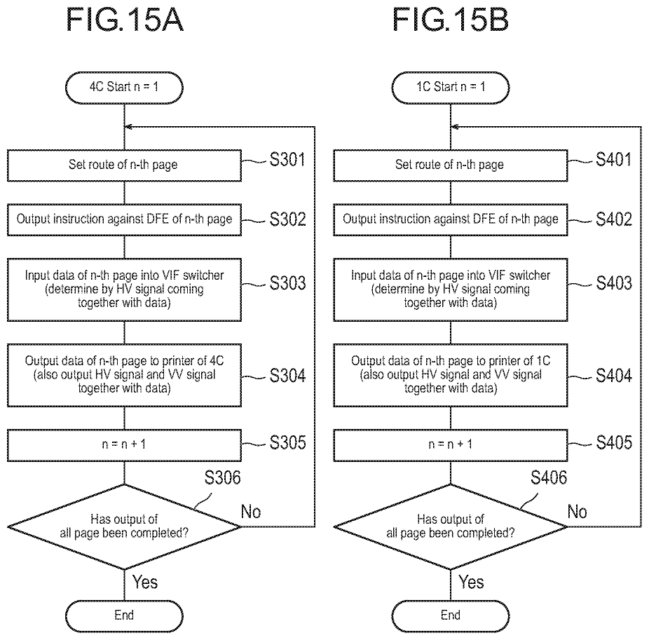

Next, a print control system, a print control method, and print control instructions according to a third example of one or more embodiments of the present invention will be described with reference to FIG. 12 through FIG. 15B. FIG. 12 is a schematic drawing showing an outlined configuration of the printing system of the present example, and FIG. 13 is a table showing the RIP prediction and RIP distribution result of each page. Moreover, FIG. 14 is a schematic drawing showing a relationship between a RIP time and a printing time, and FIGS. 15A and 15B are a flowchart diagrams showing an operation of a scalable DFE system of the present example.

In the above-described first and second examples, a case where the scalable DFE system 20 is connected to one printer 10, has been described. However, there may be also a case where printing cannot be performed by one printer 10 due to the increasing of the kinds of colors to be printed. Then, in the present example, even in the case where a plurality of printers are connected in series, RIP processing is made to be able to be executed by being distributed.

For example, as shown in FIG. 12, there may be a case where a conventional four-color printer 10a for YMCK (denoted as an engine 4C) and a one-color printer 10b for an additional color (denoted as an engine 1C) are connected in series. In this case, it is possible to process the RIP processing for the four colors and the additional one-color separately. Accordingly, the DFE administrator 31 of the DFE (1) selects the printer and DFE of an output destination appropriately on the basis of the color of each page of input manuscript data and prepare a distribution table as shown in FIG. 13. Then, in accordance with this distribution table, the VIF switcher 33 of the DFE (1) instructs the video output unit of each DFE to output and outputs data to the printer of the output destination.

For example, as shown in the schematic drawing in FIG. 14, when the RIP processing for four colors of the page 1 has been completed in the RIP processor 32, the VIF switcher 33 outputs the RIP-treated data to the printer 10a and makes the printer 10a start printing. Thereafter, the VIF switcher 33 notifies each DFE of an output instruction (a command or a HV signal), and then, each DFE starts the output of the RIP-treated data of the four colors or the additional one-color by making any one of the command and the HV signal as a trigger. Successively, if the RIP-treated data is input into the VIF switcher 33, the VIF switcher 33 transmits the RIP-treated data to the printer 10a or the printer 10b.

Hereinafter, an operation of the scalable DFE system 20 of the present example will be described with reference to FIGS. 15A and 15B. The processor of the DFE (1) develops the print control instructions memorized in a ROM and the like into a RAM and executes the print control instructions, thereby executing the processing of each step shown in flowchart diagrams in FIGS. 15A and 15B.

(Printing of Four Colors of YMCK)

As shown in FIG. 15A, the DFE administrator 31 performs the distribution of the RIP processing on the basis of the RIP processing capability (refer to FIG. 3) of each DFE and the RIP prediction (refer to FIG. 4) of each page and sets the route (DFE that executes the RIP processing) of the n-th page (S301). Next, the DFE administrator 31 performs an output instruction against the DFE administrator of the DFE to which the n-th page is distributed (S302). Then, the DFE administrator instructs the RIP processor to perform the RIP processing for the n-th page, and the video output unit outputs the RIP-treated data.

Next, when the RIP-treated data of the n-th page has been input (S303), the VIF switcher 33 outputs the RIP-treated data of the n-th page together with an HV signal and a VV signal if needed to the printer 10a (S304).

Next, the VIF switcher 33 adds one to the n (S305) and determines whether the output of all the pages has been completed (S306). In the case where the output of all the pages has not been completed (No in S306), the processing returns to S301, and the similar processing is repeated. As a result, in the case where the output of all the pages has been completed (Yes in S306), a series of processing will be ended.

(Printing of Additional One-Color)

As shown in FIG. 15B, similarly, the DFE administrator 31 performs the distribution of the RIP processing on the basis of the RIP processing capability of each DFE and the RIP prediction of each page and sets the route of the n-th page (S401). Next, the DFE administrator 31 performs an output instruction against the DFE administrator of the DFE to which the n-th page is distributed (S402). Then, the DFE administrator instructs the RIP processor to perform the RIP processing for the n-th page, and the video output unit outputs the RIP-treated data.

Next, when the RIP-treated data of the n-th page has been input (S403), the VIF switcher 33 outputs the RIP-treated data of the n-th page together with an HV signal and a VV signal if needed to the printer 10b (S404).

Next, the VIF switcher 33 adds one to the n (S405) and determines whether the output of all the pages has been completed (S406). In the case where the output of all the pages has not been completed (No in S406), the processing returns to S401, and the similar processing is repeated. As a result, in the case where the output of all the pages has been completed (Yes in S406), a series of processing will be ended.

In the above-described flow, a case where a DFE is switched in units of pages, has been described. However, as described in the second example, in the middle of the page (for example, in units of images (objects) in a page), the DFE may be switched.

As described in the above, even in the case where printing cannot be performed by one printer 10 due to the increasing of the kinds of colors to be printed, by using the scalable DFE system 20 described in the first or second example, it is possible to execute the RIP processing by distributing the RIP processing.

In this connection, the present invention should not be limited to the above-described examples. Unless departing the purpose of the present invention, its configuration and control can be changed suitably.

For example, in the above-described examples, a case where the VIF switcher is provided to any one of the print controllers, has been described. However, the scalable DFE system may be also configured as follows. That is, a VIF switching device that performs only the switching of the VIFs, may be provided to the scalable DFE system. Then, all the print controllers may be connected to the VIF switching device, and the VIF switching device may be connected to a printer. To the scalable DFE system with such a configuration, the print control method of one or more embodiments of the present invention can be similarly applied.

Although embodiments of the present invention have been described and illustrated in detail, the disclosed embodiments are made for purpose of illustration and example only and not limitation. The scope of the present invention should be interpreted by terms of the appended claims.

It is possible to utilize one or more embodiments of the present invention for a print control system including a plurality of print controllers, a print control method in the print control system, print control instructions that operate in any one of the print controllers, and a recording medium that records the print control instructions.

What is claimed is:

1. A print control system that outputs a video signal to a printer, comprising:
a plurality of print controllers comprising a first print controller and a second print controller, wherein
the first print controller is connected to a printer and comprises:
an administrator that:
acquires a print job comprising image information,
divides the image information of the acquired print job, and
distributes the divided image information to the first print controller and the second print controller; and
a first Raster Image Process (RIP) processor that generates image data by rasterizing the image information distributed to the first print controller,
the second print controller comprises:
a second Raster Image Process (RIP) processor that generates the image data by rasterizing the image information distributed to the second print controller, and
the first print controller further comprises:
a switcher that:
controls the first RIP processor or the second RIP processor to generate the image data at a timing according to a distribution result; and
switches an output route to output the generated image data to the printer.

2. The print control system according to claim 1, wherein
the administrator further:
divides the image information of the print job based on a RIP processing capability of each of the first RIP processor and the second RIP processor and a printing speed of the printer, and
creates a table showing a distribution result of the divided image information, and
the switcher further switches the output route based on the table.

3. The print control system according to claim 1, wherein
the switcher further switches the output route to output the video signal to the printer, and
the video signal comprises:
a signal corresponding to the image data generated by the first RIP processor or the second RIP processor; and
a horizontal synchronous signal.

4. The print control system according to claim 1, wherein the administrator further divides the image information of the print job for each page.

5. The print control system according to claim 1, wherein the administrator further divides the image information of the print job in a sub-scanning direction on a page.

6. A print control method in a print control system that includes a plurality of print controllers including a first print controller connected to a printer and a second print controller and that outputs a video signal to the printer, the print control method comprising:
executing, by the first print controller:
distribution processing that acquires a print job comprising image information, divides the image information of the acquired print job, and distributes the divided image information to the first print controller and the second print controller; and
first Raster Image Process (RIP) processing that generates image data by rasterizing the image information distributed to the first print controller; and
executing, by the second print controller:
second Raster Image Process (RIP) processing that generates the image data by rasterizing the image information distributed to the second print controller; and
further executing by the first print controller:
switch processing that:
causes the first RIP processing or the second RIP processing to generate the image data at a timing according to a distribution result and
switches an output route to output the generated image data to the printer.

7. The print control method according to claim 6, wherein
in the distribution processing:
further dividing the image information of the print job based on a RIP processing capability of each of the first RIP processing and the second RIP processing and a printing speed of the printer;
further creating a table showing a distribution result of the divided image information; and
in the switch processing:
further switching the output route based on the table.

8. The print control method according to claim 6, wherein
in the switch processing, further switching the output route to output the video signal to the printer, and
the video signal comprises:
a signal corresponding to the image data generated by the first RIP processing or the second RIP processing; and
a horizontal synchronous signal.

9. The print control method according to claim 6, wherein in the distribution processing, further dividing the image information of the print job for each page.

10. The print control method according to claim 6, wherein in the distribution processing, further dividing the image information of the print job in a sub-scanning direction on a page.

11. A non-transitory recording medium storing computer readable print control instructions that operate in a print control system that comprises a plurality of print controllers including a first print controller and a second print controller and that outputs a video signal to a printer, the print control instructions comprising:
connecting the first print controller to the printer; and
executing with the first print controller:
distribution processing that acquires a print job comprising image information, divides the image information of the acquired print job, and distributes the divided image information to the first print controller and the second print controller, and
switch processing that:
causes the first print controller or the second print controller to execute Raster Image Process (RIP) processing that generates image data by rasterizing the distributed image information at a timing according to a distribution result; and
switches an output route to output the generated image data to the printer.

12. The non-transitory recording medium according to claim 11, wherein
in the distribution processing:
further dividing the image information of the print job based on a RIP processing capability of each of the first print controller and the second print controller and a printing speed of the printer;
further creating a table showing a distribution result of the divided image information, and
in the switch processing:
further switching the output route based on the table.

13. The non-transitory recording medium according to claim 11, wherein
in the switch processing, further switching the output route to output the video signal to the printer, and
the video signal comprises:
a signal corresponding to the image data generated in the RIP processing executed by the first print controller or the second print controller; and
a horizontal synchronous signal.

14. The non-transitory recording medium according to claim 11, wherein in the distribution processing, further dividing the image information of the print job for each page.

15. The non-transitory recording medium according to claim 11, wherein in the distribution processing, further dividing the image information of the print job in a sub-scanning direction on a page.
